(19) United States
(12) Patent Application Publication
(10) Pub. No.: US 2008/0297462 A1
(43) Pub. Date: Dec. 4, 2008

(54) Split power supply circuit for LCD TV

(76) Inventor: Ta-Sung Hsiung, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,385

(22) Filed: Nov. 2, 2007

(30) Foreign Application Priority Data
Jun. 1, 2007 (TW) 96119842

(51) Int. Cl. G09G 3/36

(52) U.S. Cl. 345/102

(57) ABSTRACT

A liquid crystal display (LCD) television (TV) power supply circuit is split into a backlight module power supply sub-circuit and a TV circuit power supply sub-circuit, wherein the backlight module power supply sub-circuit supplies an operation voltage to a backlight module of the LCD TV and the TV circuit power supply sub-circuit supplies plural operation voltages for a TV circuit of the LCD TV. The backlight module power supply sub-circuit includes a power factor correction circuit and an inverter, and the TV circuit power supply sub-circuit includes a DC/DC converter. The backlight module power supply sub-circuit and the TV circuit power supply sub-circuit may share a common rectifier circuit or they can be provided with direct current powers by respective rectifiers.

### FIELD OF THE INVENTION

The present invention relates to a power supply circuit for a liquid crystal display (LCD) television (TV) set, and in particular to split power supply circuit for the LCD TV containing a backlight module power supply sub-circuit and a TV circuit power supply sub-circuit that are separated from each other.

### BACKGROUND OF THE INVENTION

Liquid crystal display (LCD) television (TV) set is fast popularized due to small thickness, light weight, and reduced power consumption. Thus, the traditional CRT TV sets are gradually replaced by the LCD TV sets.

In the circuit architecture of the LCD TV, a backlight module and a TV circuit are included. The backlight module functions to provide backlighting to the LCD panel. As to the supply of power for the LCD TV, the TV itself requires an operation voltage supplied from a power source to maintain the operation of the TV set. Thus, the power source must be configured to provide both an operation voltage for the TV circuit and an operation voltage for the backlight module.

FIG. 1 of the attached drawings shows a circuit block diagram of a conventional power supply circuit for a LCD TV. The LCD TV is constituted by a backlight module 11 and a TV circuit 12. Both the backlight module 11 and the TV circuit 12 require their own operation voltages that are supplied by a LCD TV power supply circuit 2.

The conventional power supply circuit 2 generally comprises an electromagnetic interference (EMI) suppression circuit 21, a rectifier circuit 22, a power factor correction (PFC) circuit 23, a direct current to direct current converter (DC/DC converter) 24, and an inverter 25. An alternating current (AC) power source ACV is supplied to the power supply circuit 2 and the EMI suppression circuit 21 filters out electromagnetic noises from the AC power ACV to suppress any troubles caused by electromagnetic interference. The AC power is then subjected to rectification by the rectifier circuit 22 to convert the AC power ACV into a direct current (DC) power source (DCV).

The DC power DCV so obtained through the rectification operation is supplied through the PFC circuit 23 for correction of power factor and is then subjected to voltage conversion carried out by the DC/DC converter 24 to provide multiple sets of operation voltages V2, V3, V4, which can be for example +5V, +12V, +24V. Two of the operation voltages V2, V3, V4, namely V2 and V3, which in the embodiment illustrated are respectively +5V and +12V, are supplied to the TV circuit 12, while the remaining one, namely V4 (+24V) is supplied to the inverter 25 to be subjected to boosting by the inverter 25 to provide a backlight module AC operation voltage V1 to the backlight module 11 of the LCD TV 1.

### SUMMARY OF THE INVENTION

The architecture of the conventional power supply circuit for a liquid crystal display (LCD) television (TV) set contains a plurality of circuit modules among which power conversion must be done. This makes certain problems, including low circuit efficiency, large noise, and increased costs for components and circuits. All the circuit modules have different circuit efficiencies. For example, for the PFC circuit, the most up-to-date technology provides an at most 94% efficiency for the PFC circuit. The DC/DC converter has a circuit efficiency of 90%, and that of the inverter is around 85%. Based on these figures, the overall circuit efficiency of the LCD TV power supply circuit has a maximum value of 72%.

Besides the drawbacks associated with the individual circuit efficiency of each circuit module and the overall circuit efficiency, there are also problems associated with the selection of the components/circuits due to the limitation of power requirement. For example, for a currently marketed 37″ LCD TV product, a 250W power supply is used and thus an electrical inductance bearing a power factor correction circuit of 250W and a transformer having a DC/DC converter taking 250W must be used.

The above description shows that the conventional LCD TV power supply circuit suffers problems of low overall efficiency and limitation in selection of power of circuit module. Thus, it is a major objective of the art to overcome such problems. This is not easy to be done with the state-of-art technology.

Thus, in view of the problems associated with the conventional LCD TV power supply circuit and further due to the fact that the state-of-art technology is insufficient to overcome such problems, an objective of the present invention is to an improvement of an LCD TV power supply circuit, which is aimed to increase the overall circuit efficiency of the LCD TV power supply circuit.

Another objective of the present invention is to provide a LCD TV power supply circuit that has a reduced power requirement for circuit modules thereof so that the circuit modules that constitute the power supply circuit can be of enhanced flexibility of selection of the components thereof.

To solve the problems associated with the conventional power supply circuit, in accordance with the present invention, a LCD TV power supply circuit is split into a backlight module power supply sub-circuit and a TV circuit power supply sub-circuit, wherein the backlight module power supply sub-circuit supplies an operation voltage to a backlight module of the LCD TV set and the TV circuit power supply sub-circuit supplies plural operation voltages for a TV circuit of the LCD TV set. The backlight module power supply sub-circuit comprises a power factor correction circuit and an inverter, while the TV circuit power supply sub-circuit comprises a DC/DC converter. The backlight module power supply sub-circuit and the TV circuit power supply sub-circuit may share a common rectifier circuit or they can be provided with direct current powers by respective rectifiers.

Compared to the conventional technology, the present invention provides a power supply circuit that employs a split architecture containing split backlight module power supply sub-circuit and TV circuit power supply sub-circuit, wherein for the backlight module of the LCD TV, an overall circuit efficiency having a minimum value of 80% can be realized and for the TV circuit, an overall circuit efficiency of 90% can be achieved. In other words, by employing the technology of the present invention, an increase of approximately 8% can be achieved for the overall efficiency of the backlight module portion, and an increase of approximately 6% can be realized for the overall efficiency of a system power supply for the TV set.

As to the power requirement for the circuit modules, the present invention provides the LCD TV with enhanced flexibility in selection of the power for circuit modules of the power supply circuit. In other words, the present invention simplifies the conversion among circuit modules for the power supply circuit provided in accordance with the present invention so that overall efficiency is enhanced and costs are reduced.

### BRIEF DESCRIPTION OF THE DRAWINGS

The present invention will be apparent to those skilled in the art by reading the following description of preferred embodiments thereof with reference to the drawings, in which:

FIG. 1 is a block circuit diagram of a conventional power supply circuit for a liquid crystal display (LCD) television (TV) set;

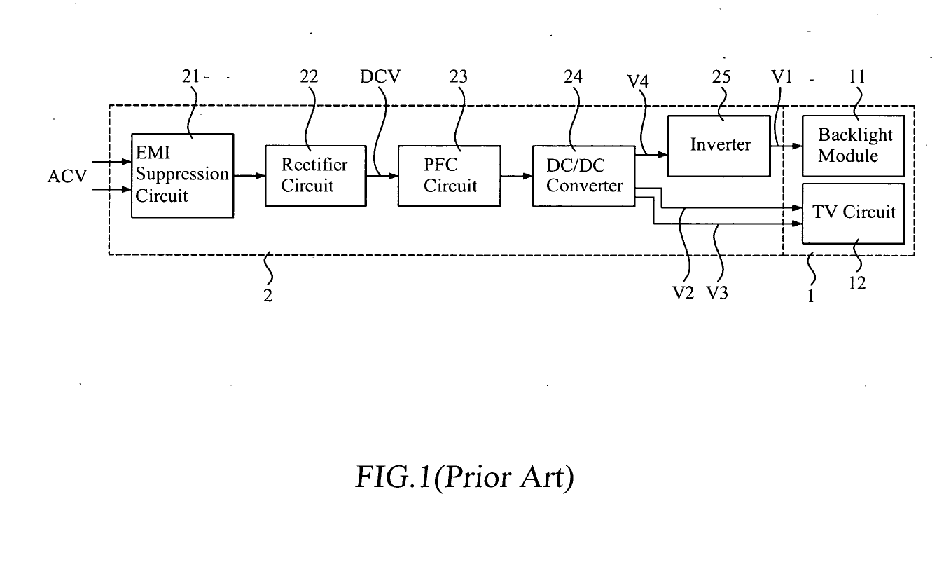

FIG. 2 is a block circuit diagram of a split power supply circuit constructed in accordance with a first embodiment of the present invention for supplying power to a LCD TV; and

FIG. 3 is a block circuit diagram of a split power supply circuit constructed in accordance with a second embodiment of the present invention for supplying power to a LCD TV.

### DETAILED DESCRIPTION OF THE PREFERRED EMBODIMENTS

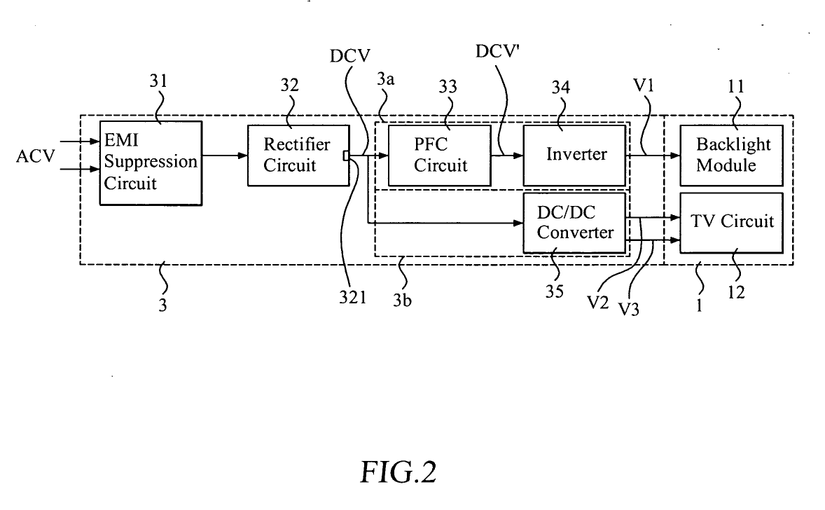

With reference to the drawings and in particular to FIG. 2, which shows a split power supply circuit, generally designated with reference numeral 3, constructed in accordance with a first embodiment of the present invention, which is provided for powering a liquid crystal display (LCD) television set (TV), the split power supply circuit of the present invention comprises an electromagnetic interference (EMI) suppression circuit 31 and a rectifier circuit 32. The rectifier circuit 32 is connected through the EMI suppression circuit 31 to an alternating current (AC) power source ACV to receive an AC power from the power source ACV and converts the AC power into a direct current (DC) power source (DCV). The DC power is supplied through a DC output terminal 321.

In accordance with the present invention, the power supply circuit is divided into two power supply sub-circuits. In other words, the power supply circuit 3 includes a backlight module power supply sub-circuit 3a and a TV power supply sub-circuit 3b. The backlight module power supply sub-circuit 3a comprises a power factor correction (PFC) circuit 33 connected to the DC output terminal 321 of the rectifier circuit 32 to carry out correction of power factor for the DC power source DCV supplied at the DC output terminal 321 and thus provide a power-factor-corrected DC power DCV′. An inverter 34 is connected to the PFC circuit 33, functioning to boost the power-factor-corrected DC power DCV′ and supply backlight module operation voltage V1 of a rated voltage level to the backlight module 11.

The TV power supply sub-circuit 3b includes a DC/DC converter 35, which is connected to the DC output terminal 321 of the rectifier circuit 32 to convert the DC power DCV from the DC output terminal 321 into a plurality of operation voltages V2, V3 of rated voltage levels to a TV circuit 12. For example, the operation voltages V2, V3 supplied from the DC-to-DC converter 35 can be +5V and +12V.

In the power supply circuit of the present invention, two split circuits are respectively employed to supply power to the backlight module and the TV circuit of the TV set. With such an arrangement, for the backlight module, power is supplied through the EMI suppression circuit 31, the rectifier circuit 32, the PFC circuit 33 (having an efficiency of 94%), and the inverter (having an efficiency of 85%) to the backlight module 11 and an overall circuit efficiency of approximately 80% may be realized. For the TV circuit 12, power is supplied through the EMI suppression circuit 31, the rectifier circuit 32, and the DC/DC converter 35 (having an efficiency of 90%) to the TV circuit 12 and an overall circuit efficiency of approximately 90% can be realized. Apparently, for the part of the backlight module, an increase of at 8% is achieved for overall efficiency of the backlight module; and for the part of the system power, an increase of at least 6% of the overall efficiency thereof is realized.

As to the power requirement for the circuit modules, for a currently marketed 37″ LCD TV that requires a power supply of 250W, an electrical inductance of the PFC circuit must bear the 250W power and similarly the DC/DC converter must have a transformer that takes the power of 250W. However, for the power supply circuit of the present invention, the PFC circuit needs an electrical inductance that takes only 200W and the DC/DC converter requires only a transformer of 50W. Apparently, the power supply circuit of the present invention can reduce the volume and the costs of the PFC circuit and the DC/DC converter and also provides enhanced flexibility for selection of power of the circuit modules. Thus, using the circuit of the present invention, conversion among circuit modules of the overall circuit architecture of the power supply circuit can be reduced and the overall efficiency is enhanced and the costs reduced.

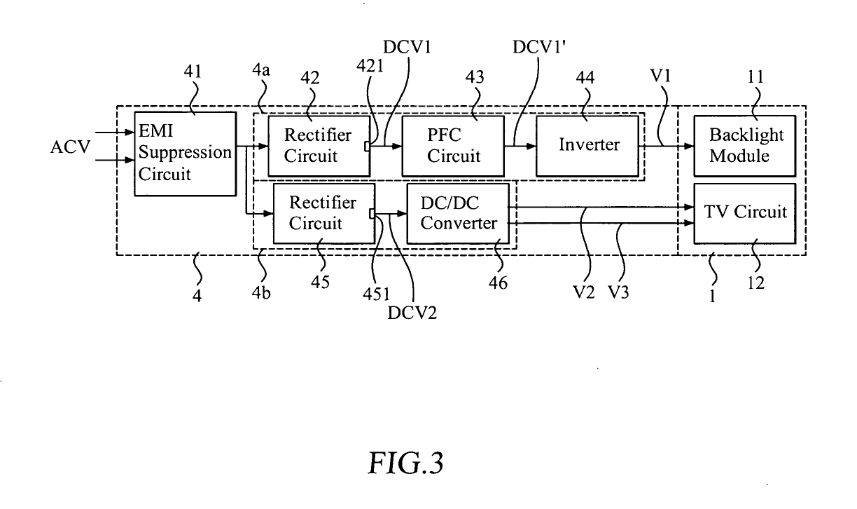

Referring to FIG. 3, which shows a split power supply circuit, generally designated with reference numeral 4, constructed in accordance with a second embodiment of the present invention, which is also provided for powering an LCD TV, the split power supply circuit of the second embodiment of the present invention is also constituted by a backlight module power supply sub-circuit 4a and a TV power supply sub-circuit 4b. The backlight module power supply sub-circuit 4a comprises a first rectifier circuit 42, which is connected through an electromagnetic interference (EMI) suppression circuit 41 to an alternating current (AC) power source ACV to receive an alternating current (AC) from the power source ACV and converts the AC into a first direct current power source (DCV1). The first DC power DCV1 is supplied through a DC output terminal 421. A power factor correction (PFC) circuit 43 is connected to the DC output terminal 421 of the rectifier circuit 42 to carry out correction of power factor for the first DC power source DCV1 supplied at the DC output terminal 421 and thus provide a power-factor-corrected DC power DCV1′. An inverter 44 is connected to the PFC circuit 43, functioning to boost the power-factor-corrected DC power DCV1′ and supply backlight module operation voltage V1 of a rated voltage level to the backlight module 11.

The TV power supply sub-circuit 4b includes a second rectifier circuit 45 that is connected through the EMI suppression circuit 41 to the AC power source ACV to receive an AC power and convert the AC power into a second DC power DCV2. The second DC power DCV2 is supplied through a DC output terminal 451. A DC/DC converter 46 is connected to the DC output terminal 451 of the second rectifier circuit 45 to convert the second DC power DCV2 from the DC output terminal 451 into a plurality of operation voltages V2, V3 of rated voltage levels to a TV circuit 12.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A split power supply circuit for supplying respective operation voltages to a backlight module and a television circuit of a liquid crystal display television set, the split power supply circuit comprising:
a rectifier, which is adapted to connect to an alternating current power source to receive an alternating current power from the alternating current power source and convert the alternating current power into a direct current power, and which comprises a direct current output terminal that supplies the direct current power;
a backlight module power supply sub-circuit comprising:
a power factor correction circuit, which is connected to the direct current output terminal of the rectifier to receive and subject the direct current power to power factor correction so as to provide a power-factor-corrected direct current power, and
an inverter, which is connected to the power factor correction circuit to boost the power-factor-corrected direct current power for providing a backlight module operation voltage of a rated voltage level to the backlight module; and
a television circuit power supply sub-circuit comprising:
a direct current to direct current converter, which is connected to the direct current output terminal of the rectifier to receive and convert the direct current power into a plurality of operation voltages of respective rated voltage levels to the television circuit.

2. The split power supply circuit as claimed in claim 1, wherein the rectifier is connected through an electromagnetic interference suppression circuit to the alternating current power source.

3. A split power supply circuit for supplying respective operation voltages to a backlight module and a television circuit of a liquid crystal display television set, the split power supply circuit comprising:
a backlight module power supply sub-circuit comprising:
a first rectifier, which is adapted to connect to an alternating current power source to receive an alternating current power from the alternating current power source and convert the alternating current power into a first direct current power, and which comprises a direct current output terminal that supplies the first direct current power,
a power factor correction circuit, which is connected to the direct current output terminal of the first rectifier to receive and subject the first direct current power to power factor correction so as to provide a power-factor-corrected direct current power, and
an inverter, which is connected to the power factor correction circuit to boost the power-factor-corrected direct current power for providing a backlight module operation voltage of a rated voltage level to the backlight module; and
a television circuit power supply sub-circuit comprising:
a second rectifier, which is adapted to connect to the alternating current power source to receive an alternating current power from the alternating current power source and convert the alternating current power into a second direct current power, and which comprises a direct current output terminal that supplies the second direct current power, and
a direct current to direct current converter, which is connected to the direct current output terminal of the second rectifier to receive and convert the second direct current power into a plurality of operation voltages of respective rated voltage levels to the television circuit.

4. The split power supply circuit as claimed in claim 3, wherein the first and second rectifiers are connected through an electromagnetic interference suppression circuit to the alternating current power source.
